(19) United States
(12) Patent Application Publication
(10) Pub. No.: US 2016/0253969 A1
(43) Pub. Date: Sep. 1, 2016

(54) CURVED DISPLAY PANEL AND CURVED DISPLAY DEVICE

(71) Applicant: SHENZHEN CHINA STAR OPTOELECTRONICS TECHNOLOGY CO., LTD., Shenzhen, Guangdong (CN)

(72) Inventors: Cheng-Hung Chen, Shenzhen, Guangdong (CN); Shih-Hsun Lo, Shenzhen, Guangdong (CN); Chuan Wu, Shenzhen, Guangdong (CN)

(21) Appl. No.: 14/389,582

(22) PCT Filed: Jul. 2, 2014
(86) PCT No.: PCT/CN2014/081520

§ 371 Date: Sep. 30, 2014

(30) Foreign Application Priority Data
Jun. 27, 2014 (CN) 201410300826.X

(51) Int. Cl. G09G 3/36

(52) U.S. Cl. CPC G09G 3/3607; G09G 3/3677; G09G 3/3688; G09G 2300/0452; G09G 2320/0233; G09G 2320/0242; G09G 2300/04; G09G 2360/06

(57) ABSTRACT

Disclosed are a curved display panel and a curved display device. The curved display panel employs two data driving circuits which simultaneously output data signals to a same data line, and two scan driving circuits which simultaneously output scan signals to the same scan line, so that problems such as an image signal being distorted due to a terminal signal of a data line being seriously decayed, and a non-uniform display in brightness due to the scan line 202 being undercharged are prevented.

### FIELD OF THE INVENTION

The present invention relates to the field of display panel technology, more particularly, to a curved display panel and a curved display device.

### BACKGROUND OF THE INVENTION

In general, in the field of curved thin film transistor-liquid crystal displays (TFT-LCD), a scan line 101 is parallel to a long side 100a of the curved display device (i.e., parallel to an arc of the curved surface), and a data line 102 is perpendicular to the long side 100a of the curved display panel. A long side 11a of each pixel 11 is perpendicular to the long side 100a of the curved display panel (i.e. each pixel 11 is arranged vertically). Refer to FIG. 1a, which uses the pixel 11 as an example to illustrate a pixel structure of the conventional curved TFT-LCD, where the reference number 100b represents a short side of the curved display panel, and the reference number 11b represents a short side of the pixel.

Since the data line and the scan line are formed by using copper or silver, which have resistances and generate capacitances with other portions of the display panel, signals will decay gradually in the signal transmission. With the increase of the size and resolution of the display panel, the RC load will increase, so that an image signal is distorted since a terminal signal of the data line is seriously decayed. Moreover, since the scan line is undercharged, the display is non-uniform in brightness.

Therefore, it is necessary to provide a new technical solution to solve the above technical problems.

### SUMMARY OF THE INVENTION

The object of the present invent is to provide a curved display panel and a curved display device which can reduce obvious black areas and color casts formed on the right and left regions of the display panel, so that an aperture ratio is increased. The problems such as an image signal being distorted since a terminal signal of a data line is seriously decayed, and a non-uniform display in brightness due to the scan line being undercharged are prevented.

In order to solve the above-mentioned problems, the technical solution of the embodiment of the present invention is as follows:

A curved display panel comprises a pixel structure disposed on the curved display panel, a data line used to a provide data signal to the pixel structure, and a scan line used to provide a switching control signal to the pixel structure;

four rims of the curved display panel consist of two first rims and two second rims, the first rim is neighbored to the second rim, the first rim is a curved rim, and a length of the first rim is greater than a length of the second rim, wherein the pixel structure comprises:

at least two pixel units, wherein each of the pixel units comprises at least three sub-pixels, each of the sub-pixels is configured as a rectangle, each of the sub-pixels comprises a long side and a short side;

two data driving circuits being respectively disposed on a corresponding outside of the first rims, wherein the data driving circuit disposed on the outside of one of the first rims and the data driving circuit disposed on the outside of the other first rim are connected to a same data line, the two data driving circuits simultaneously output the data signals to the same data line; and

two scan driving circuits being respectively disposed on a corresponding outside of the second rims, wherein the scan driving circuit disposed on the outside of one of the second rims and the scan driving circuit disposed on the outside of the other second rim are connected to a same scan line, the two scan driving circuits simultaneously output scan signals to the same scan line.

In the above-mentioned curved display panel, the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

In the above-mentioned curved display panel, the scan line is perpendicular to the first rim and parallel to the second rim.

In the above-mentioned curved display panel, the data line is perpendicular to the second rim and parallel to the first rim.

In the above-mentioned curved display panel, the data driving circuit and the scan driving circuit are packaged by using a chip-on-film (COF) packaging technology.

A curved display panel comprises a pixel structure disposed on the curved display panel, a data line used to provide a data signal to the pixel structure, and a scan line used to provide a switching control signal to the pixel structure;

four rims of the curved display panel consist of two first rims and two second rims, the first rim is neighbored to the second rim, the first rim is a curved rim, and a length of the first rim is greater than a length of the second rim, the pixel structure comprises:

at least two pixel units, wherein each of the pixel units comprises at least three sub-pixels, each of the sub-pixels is configured as a rectangle, each of the sub-pixels comprises a long side and a short side;

two data driving circuits being respectively disposed on a corresponding outside of the first rims, wherein the two data driving circuits simultaneously output the data signals to the same data line; and

two scan driving circuits being respectively disposed on a corresponding outside of the second rims, wherein the two scan driving circuits simultaneously output scan signals to the same scan line.

In the above-mentioned curved display panel, the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

In the above-mentioned curved display panel, the data driving circuit disposed on an outside of one of the first rims and the other data driving circuit disposed on an outside of the other first rim are connected to the same data line

In the above-mentioned curved display panel, the scan driving circuit disposed on an outside of one of the second rims and the other scan driving circuit disposed on an outside of the other second rim are connected to a same scan line.

In the above-mentioned curved display panel, the scan line is perpendicular to the first rim and parallel to the second rim.

In the above-mentioned curved display panel, the data line is perpendicular to the second rim and parallel to the first rim.

In the above-mentioned curved display panel, the data driving circuit and the scan driving circuit are packaged by using a chip-on-film (COF) packaging technology.

A curved display device comprises a curved display panel, a pixel structure disposed on the curved display panel, a data line used to provide a data signal to the pixel structure, and a scan line used to provide a switching control signal to the pixel structure;

four rims of the curved display panel consist of two first rims and two second rims, the first rim is neighbored to the second rim, the first rim is a curved rim, and a length of the first rim is greater than a length of the second rim, the pixel structure comprises:

at least two pixel units, wherein each of the pixel units comprises at least three sub-pixels, each of the sub-pixels is configured as a rectangle, each of the sub-pixels comprises a long side and a short side;

two data driving circuits being respectively disposed on a corresponding outside of the first rims, wherein the two data driving circuits simultaneously output the data signals to a same data line; and

two scan driving circuits being respectively disposed on a corresponding outside of the second rims, wherein the two scan driving circuits simultaneously output scan signals to the same scan line.

In above-mentioned curved display device, the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

In above-mentioned curved display device, the data driving circuit disposed on an outside of one of the first rims and the other data driving circuit disposed on an outside of the other first rim are connected to the same data line; the scan driving circuit disposed on an outside of one of the second rims and the other scan driving circuit disposed on an outside of the other second rim are connected to the same scan line.

In comparison to the prior art, in the curved display panel of the present invention, the curved display panel employs two data driving circuits to simultaneously drive the same data line and two scan driving circuits to simultaneously drive the same scan line, so that the problems such as an image signal being distorted since a terminal signal of a data line is seriously decayed, and a non-uniform display in brightness due to the scan line being undercharged are prevented. Furthermore, the long side of each of the sub-pixels is parallel to the long side rim of the curved display panel, and the short side of each of the sub-pixels is parallel to the short side rim of the curved display panel, so that black regions on both sides of the curved display panel can be reduced, the color casts formed on the right and left regions of the curved display panel can be improved, and a non-uniform display in brightness of the curved display panel can be improved.

### BRIEF DESCRIPTION OF THE DRAWINGS

FIG. 1a to FIG. 1c show schematic diagrams of a conventional curved TFT-LCD.

FIG. 2 shows a schematic diagram of a curved display panel according to the present invention.

FIG. 3 shows another schematic diagram of a curved display panel according to the present invention.

FIG. 4 shows a schematic diagram of a pixel structure of a curved display panel according to the present invention.

FIG. 5 shows a schematic diagram of a curved display device according to the present invention.

### DETAILED DESCRIPTION OF THE INVENTION

Please refer to drawings, where the same reference symbol represents the same component. The principle of the present invention is that embodiments are employed in a suitable computing environment, which is used as an example for description. The following descriptions are merely specific exemplary embodiments of the present invention, but should not be construed to limit other embodiments that are not disclosed in detail herein.

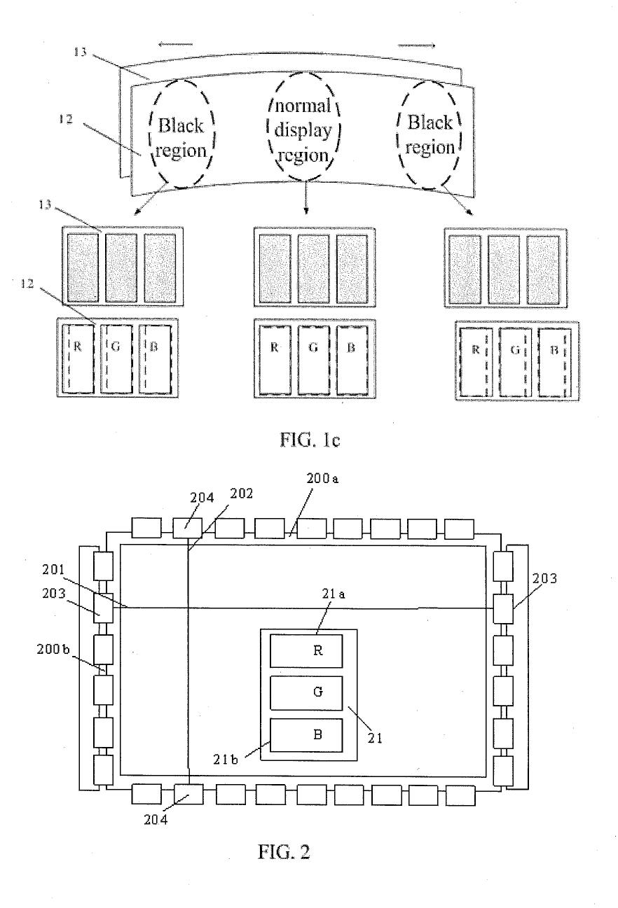

Please refer to FIG. 2, which shows a schematic diagram of a curved display panel 200 according to the present invention. The curved display panel 200 comprises a pixel structure disposed on the curved display panel 200, a data line 201 used to provide data signal to the pixel structure, and a scan line 202 used to provide switching control signal to the pixel structure.

Four rims of the curved display panel 200 consist of two first rims 200a and two second rims 200b, the first rim 200a is neighbored to the second rim 200b, the first rim 200a is a curved rim, and the length of the first rim 200a is greater than the length of the second rim 200b. The pixel structure comprises:

At least two pixel units 21, where each the pixel unit 21 comprises at least three sub-pixels, each sub-pixel is configured as a rectangle, each sub-pixel comprises a long side 21a and a short side 21b;

Two data driving circuits 203 being respectively disposed on a corresponding outside of the first rims 200a, where the two data driving circuits 203 simultaneously output the data signals to the same data line 201; and

Two scan driving circuits 204 being respectively disposed on a corresponding outside of the second rims 200b, where the two scan driving circuits 204 simultaneously output scan signals to the same scan line 202.

It should be understood that FIG. 2 uses a pixel unit 21 as an example to illustrate a pixel structure of the curved display panel 200, but does not limit the present invention. It is to be understood that each pixel unit 21 may include three sub-pixels, which are a red sub-pixel R, a green sub-pixel G, and a blue sub-pixel B, or each pixel unit 21 may include four sub-pixels, which are a white a sub-pixel W, red sub-pixel R, a green sub-pixel G, and a blue sub-pixel B. These two pixel unit structures can be employed in the curved display panel 200, which is not limited here specifically.

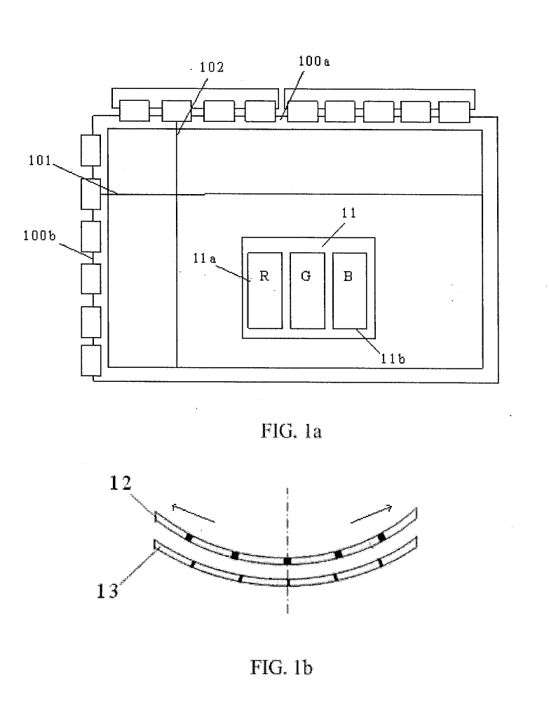

For the conventional curved display panel as shown in FIG. 1a, an origin point of an upper substrate 12 (color filter (CF) substrate) and a bottom substrate 13 (TFT substrate) are the center of the display panel, and a relative displacement is gradually generated in a horizontal direction to the left and right, so that a larger relative displacement is generated on the left and right sides of the bottom substrate of the display panel. Refer to FIG. 1b and FIG. 1c, which show schematic diagrams of a conventional curved display device. Since the relative displacement on the bottom substrate is large, much light is shaded by a black matrix and an aperture ratio will be reduced. Therefore, the brightness of the left and right regions are reduced, and obvious black areas on left and right regions of the display panel will be seen. When the relative displacement is large, the colors of a leakage of the light are different, so that the existence of large color casts are formed on the left and right black regions.

Preferably, in the present invention, the long side 21a of each sub-pixel is parallel with the first rim 200a, the short side 21b of each sub-pixel is parallel with the second rim 200b, the long side 21a of each sub-pixel is perpendicular to the second rim 200b, and the short side 21b of each sub-pixel is perpendicular to the first rim 200a, so as to reduce the black areas and color casts formed on the left and right regions of the curved display panel.

Preferably, the data driving circuit 203 disposed on an outside of one of the first rims 200a and the other data driving circuit 203 disposed on an outside of the other first rim 200a are connected to a same data line 201, where the two data driving circuits 203 connected to a same data line simultaneously output data signals having the same magnitude to the same data line.

Preferably, the scan driving circuit 204 disposed on an outside of one of the second rims 200b and the other scan driving circuit 204 disposed on an outside of the other second rim 200b are connected to a same scan line 202, where the two scan driving circuits 204 connected to a same can line simultaneously output scan signals having the same magnitude to the same scan line.

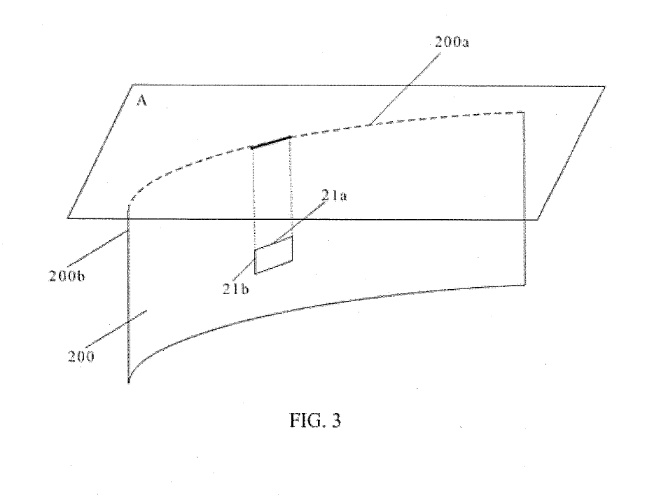

Refer to FIG. 3, which shows another schematic diagram of the curved display panel 200, where the first rim 200a is a curved rim. That is, the first rim 200 is a long side of the curved display panel 200, and the second rim 200b is a short side of the curved display panel 200, and the second rim 200b is perpendicular to a plane A where the first rim 200a is located.

Further, as shown in FIG. 3, the sub-pixel is disposed on the curved display panel 200. The long side 21a of the sub-pixel is perpendicular to the second rim 200b, and the long side 21a of the sub-pixel is parallel with the plane A. The short side 21b of the sub-pixel is parallel to the second rim 200b, and the short side 21b of the sub-pixel is perpendicular to the plane A where the first rim 200a is located. It is should be understood, referring to FIG. 2 and FIG. 3, according to the above analysis, that the first rim 200a is a curved rim, but that the length of the long side 21a of the sub-pixel is much less than the length of the curved rim. Hence, in the embodiment of the present invention, it can be seen that the long side 21a of the sub-pixel is parallel to the curved rim (i.e. first rim 200a), and that the short side 21b of the sub-pixel is perpendicular to the first rim 200a.

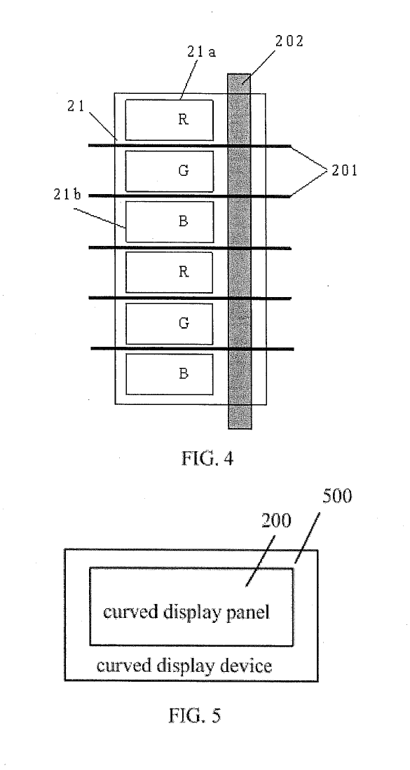

Moreover, please refer to FIG. 2, the scan line 202 is perpendicular to the first rim 200a and parallel to the second rim 200b. The data line 201 is perpendicular to the second rim 200b and parallel to the first rim 200a. That is, the scan line 202 is parallel to the short side 21b of the sub-pixel, and the data line 201 is parallel to the long side 21a of the sub-pixel. Refer to FIG. 4, which shows schematic diagram of the connection relationship between the pixel units with the data line 201 and the scan line 202 of the embodiment of the present invention. As shown in FIG. 4, the connection relationship is illustrated by two pixel units with the data line 201 and the scan line 202, but this does not limit the present invention.

In this case, the interpretation of the structure of the curved display panel 200 as shown in FIG. 2 is as follows.

In a first aspect, in comparison to the curved display panel as shown in FIG. 1, each sub-pixel of the present invention is in a horizontal arrangement. That is, the long side 21a of each sub-pixel is parallel to the first rim 200a, and the short side 21b of each sub-pixel is parallel to the second rim 200b, as shown in FIG. 2 and FIG. 3. The black regions on the both sides of the curved display panel can be reduced via this arrangement of the curved display panel 200, so that a non-uniform display of the curved display panel is improved.

The comparative analysis of an aperture region of the conventional curved display panel structure (as shown in FIG. 1a) and an aperture region of the curved display panel 200 according to the present invention (as shown in FIG. 2) is as follows.

In the structure of the curved display panel as shown in FIG. 1a, the scan line 101 is parallel to the long side 100a of the curved display device (i.e. parallel to the curved rim), the data line 102 is perpendicular to the long side 100a of the curved display panel, and the long side 11a of each sub-pixel 11 is perpendicular to the long side 100a of the curved display panel, where the length of the long side 100a of the sub-pixel 11 is m, and the length of the short side 11b is n.

According to the analysis of the force applied on the glass, referring to FIG. 1b and FIG. 1c, the relative displacement gradually becomes larger in the center of the display panel towards the left and right sides of the long side 100a of the curved display device, and the displacement direction of the left side is opposite that of the right side. According to the direction and the quality of the relative displacement, if the displacement quality of one sub-pixel is (s) urn, a light shading area (loss of aperture region) of one sub-pixel is (m×s) um².

In the structure of the curved display panel as shown in FIG. 2, the long side 21a of each sub-pixel is parallel to the first rim 200a, the short side 21b of each sub-pixel is parallel to the second rim 200b, the long side 21a of each sub-pixel is perpendicular to the second rim 200b, and the short side 21 of each sub-pixel is perpendicular to the first rim 200a. The scan line 202 is perpendicular to the first rim 200a and parallel to the second rim 200b. The data line 201 is perpendicular to the second rim 200b and parallel to the first rim 200a.

It is should be understood, in a same displacement quality situation, a loss of aperture region is (m×s) um² is at a fixed point. However, the value of m is much greater than the value of n, so that a loss of aperture region of the structure of the curved display panel according to the present invention is much less than that of a conventional curved display panel. Therefore, a bad display effect caused by a large loss of aperture region can be reduced. That is, black regions on both sides of the curved display panel can be reduced, and color casts formed on the right and left regions of the curved display panel can also be reduced, so that a non-uniform display of the curved display panel is improved.

In a second aspect, in comparison to the curved display panel as shown in FIG. 1, the curved display panel 200 of the present invention (as shown in FIG. 2) employs the data driving circuits 203 disposed on left and right rims simultaneously to drive the data line 201, and the scan driving circuits 204 disposed on the upper and bottom rims simultaneously to drive the scan line 202, so that the problems such as an image signal being distorted since a terminal signal of a data line 201 is seriously decayed, and a non-uniform the display in brightness due to the scan line 202 being undercharged are improved.

The principle of driving the curved display panel 200 according to the present invention is analyzed as follows.

In this embodiment, the data driving circuit 203 and the scan driving circuit 204 are packaged by using a chip-on-film (COF) packaging technology. The COF is a packaging technology to fix an IC on a flexible circuit board. This technology is employed by using a flexible additional circuit board as a carrier for packaging the IC to connect the IC and the flexible circuit board.

As shown in FIG. 2, The COFs used for outputting data signals to the data line 201 are disposed on the two first rims 200a (i.e. the upper rim and bottom rim of the curved display panel 200). The COF disposed on the upper rim is connected with the COF disposed on the bottom rim by the data line 201, where the two COFs connected to a same data line simultaneously output the data signals to the same data line, so as to provide the data signals by the data line 201 to the sub-pixels in a same row, so that the decay of the terminal signal of the data line is prevented.

The COFs used for outputting scan signals to the scan line 202 are disposed on the two second rims 200b (i.e. the left rim and right rim of the curved display panel 200). The COF disposed on the left rim is connected with the COF disposed on the right rim by the scan line 202, where the two COFs connected to a same scan line simultaneously output the scan signals to the same scan line, so that the scan line 202 provides the switching control signals to the sub-pixels in a same column, and a non-uniform display in brightness due to the scan line being undercharged is prevented.

It is should be understood that FIG. 2 only illustrates connection relationships in which one data line 201 connected with the COF (203), and one scan line connected with the COF (204); these can be references for another data line and scan line, but do not limit the present invention.

From the above, in the curved display panel 200 according to the present invention, each sub-pixel is in a horizontal arrangement. That is, the long side 21a of each sub-pixel is parallel to the long side 200a of the curved display panel, and the short side 21b of each sub-pixel is parallel to the short side 200b of the curved display panel. The black regions on the both sides of the curved display panel 200 can be reduced via this arrangement of the curved display panel 200. Also, the color casts formed on the right and left regions of the curved display panel 200 can be reduced, so that a non-uniform display of the curved display panel 200 is improved. Further, the two COFs connected to a same data line 201 simultaneously output the data signals having the same magnitude to the same data line 201, so as to provide the data signals by the data line 201 to the sub-pixels in the same row, so that the decay of the terminal signal of the data line is prevented. The two COFs connected to a same scan line 202 simultaneously output the scan signals having the same magnitude to the same scan line 202, so as to provide the switching control signals by the scan line 202 to the sub-pixels in the same column, so that a non-uniform display in brightness due to the scan line being undercharged is prevented.

For implementing the curved display panel according to the embodiment of the present invention, a curved display device comprising the curved display panel is further provided. The definitions of terms are same in as the above-mentioned curved display panel. For specific implementation details, reference may be made to the description in the embodiment of the curved display panel.

Please refer to FIG. 5, which shows a schematic diagram of a curved display device 500 according to the present invention. The curved display device 500 comprises the curved display panel 200 as shown in FIG. 2.

The curved display panel 200 comprises a pixel structure disposed on the curved display panel 200, a data line 201 used to provide data signal to the pixel structure, and a scan line 202 used to provide a switching control signal to the pixel structure.

Four rims of the curved display panel 200 consist of two first rims 200a and two second rims 200b, the first rim 200a is neighbored to the second rim 200b, the first rim 200a is a curved rim, and the length of the first rim 200a is greater than the length of the second rim 200b, where the pixel structure comprises:

At least two pixel units 21, where each the pixel unit 21 comprises at least three sub-pixels, each sub-pixel is configured as a rectangle, and each sub-pixel comprises a long side 21a and a short side 21b;

Two data driving circuits 203 being respectively disposed on a corresponding outside of the first rims 200a, where the two data driving circuits 203 simultaneously output the data signals to the same data line 201; and

Two scan driving circuits 204 being respectively disposed on a corresponding outside of the second rims 200b, where the two scan driving circuits 204 simultaneously output scan signals to the same scan line 202.

It should be understood that FIG. 2 uses a pixel unit 21 as an example to illustrate a pixel structure of the curved display panel 200, but does not limit the present invention. It is to be understood that each pixel unit 21 may include three sub-pixels, which are a red sub-pixel R, a green sub-pixel G, and a blue sub-pixel B, or each pixel unit 21 may include four sub-pixels, which are a white a sub-pixel W, red sub-pixel R, a green sub-pixel G, and a blue sub-pixel B. These two pixel unit structures can be employed in the curved display panel 200, which is not limited here specifically.

Preferably, the long side 21a of each sub-pixel is parallel with the first rim 200a, the short side 21b of each sub-pixel is parallel with the second rim 200b, the long side 21a of each sub-pixel is perpendicular to the second rim 200b, and the short side 21b of each sub-pixel is perpendicular to the first rim 200a.

Preferably, the data driving circuit 203 disposed on an outside of one of the first rims 200a and the other data driving circuit 203 disposed on an outside of the other first rim 200a are connected to a same data line 201, where the two data driving circuits 203 connected to a same data line simultaneously output data signals having the same magnitude to the same data line.

Preferably, the scan driving circuit 204 disposed on an outside of one of the second rims 200b and the other scan driving circuit 204 disposed on an outside of the other second rim 200b are connected to a same scan line 202, where the two scan driving circuits 204 connected to a same scan line simultaneously output scan signals having the same magnitude to the same scan line.

Refer to FIG. 3, which shows another schematic diagram of the curved display panel 200, where the first rim 200a is a curved rim. That is, the first rim 200 is a long side of the curved display panel 200, the second rim 200b is a short side of the curved display panel 200, and the second rim 200b is perpendicular to a plane A where the first rim 200a is located.

Further, as shown in FIG. 3, the sub-pixel is disposed on the curved display panel 200. The long side 21a of the sub-pixel is perpendicular to the second rim 200b, and the long side 21a of the sub-pixel is parallel to the plane A. The short side 21b of the sub-pixel is parallel to the second rim 200b, and the short side 21b of the sub-pixel is perpendicular to the plane A where the first rim 200a is located. It is should be understood, referring to FIG. 2 and FIG. 3, according to the above analysis, that the first rim 200a is a curved rim, but that the length of the long side 21a of the sub-pixel is much less than the length of the curved rim. Hence, in the embodiment of the present invention, it can be seen that the long side 21a of the sub-pixel is parallel to the curved rim (i.e. first rim 200a), and that the short side 21b of the sub-pixel is perpendicular to the first rim 200a.

Moreover, please refer to FIG. 2, the scan line 202 is perpendicular to the first rim 200a and parallel with the second rim 200b. The data line 201 is perpendicular to the second rim 200b and parallel with the first rim 200a. That is, the scan line 202 is parallel with the short side 21b of the sub-pixel, and the data line 201 is parallel with the long side 21a of the sub-pixel. Refer to FIG. 4, which shows a schematic diagram of the connection relationship between the pixel units with the data line 201 and the scan line 202 of the embodiment of the present invention. As shown in FIG. 4, the connection relationship is illustrated by two pixel units with the data line 201 and the scan line 202, but this does not limit the present invention.

The comparative analysis of an aperture region of the conventional curved display panel structure (as shown in FIG. 1a) and an aperture region of the curved display panel 200 according to the present invention (as shown in FIG. 2) is as follows.

In the structure of the curved display panel as shown in FIG. 1a, according to the analysis of the force applied on the glass, referring to FIG. 1b and FIG. 1c, the relative displacement gradually becomes larger in the center of the display panel towards the left and right sides of the long side 100a of the curved display device, and the displacement direction of the left side is opposite that of the right side. According to the direction and the quality of the relative displacement, if the displacement quality of one sub-pixel is (s) um, a light shading area (loss of aperture region) of one sub-pixel is (m×s) um².

In the structure of the curved display panel 200 as shown in FIG. 2, in a same displacement quality situation, a loss of aperture region is (m×s) um² is at a fixed point. However, the value of m is much greater than the value of n, so that a loss of aperture region of the structure of the curved display panel according to the present invention is much less than in a conventional curved display panel. Therefore, a bad display effect caused by a large loss of aperture region can be reduced.

It should be noted that in comparison to the curved display panel as shown in FIG. 1, the curved display panel 200 of the present invention (as shown in FIG. 2) employs the data driving circuits 203 being disposed on left and right rims simultaneously to drive the data line 201, and the scan driving circuits 204 being disposed on the upper and bottom rims simultaneously to drive the scan line 202, so that the problems such as an image signal being distorted since a terminal signal of a data line 201 being seriously decayed, and a non-uniform display in brightness due to the scan line 202 being undercharged are prevented.

The principle of driving the curved display panel 200 according to the present invention is analyzed as follows.

In this embodiment, the data driving circuit 203 and the scan driving circuit 204 are packaged by using a chip-on-film (COF) packaging technology. As shown in FIG. 2, the COFs used for outputting data signals to the data line 201 are disposed on the two first rims 200a (i.e. the upper rim and bottom rim of the curved display panel 200). The COF disposed on the upper rim is connected with the COF disposed on the bottom rim by the data line 201, where the two COFs connected to a same data line simultaneously output the data signals having the same magnitude to the same data line.

The COFs used for outputting scan signals to the scan line 202 are disposed on the two second rims 200b (i.e. the left rim and right rim of the curved display panel 200). The COF disposed on the left rim is connected with the COF disposed on the right rim by the scan line 202, where the two COFs connected to a same scan line simultaneously output the scan signals to the same scan line.

It is should be understood that FIG. 2 only illustrates connection relationships in which one data line 201 is connected with the COF, and one scan line is connected with the COF; these can be references for another data line and scan line, but do not limit the present invention.

From the above, the curved display device 500 according to the present invention comprises the curved display panel 200 as described above, and each sub-pixel is in a horizontal arrangement. That is, the long side 21a of each sub-pixel is parallel to the long side 200a of the curved display panel, and the short side 21b of each sub-pixel is parallel to the short side 200b of the curved display panel. The black regions on the both sides of the curved display panel 200 can be reduced via this arrangement of the curved display panel 200. Also, the color casts formed on the right and left regions of the curved display panel 200 can be reduced, so that a non-uniform display of the curved display panel 200 is improved. Further, the two COFs connected to a same data line 201 simultaneously output the data signals having the same magnitude to the same data line 201, so as to provide the data signals by the data line 201 to the sub-pixels in the same row, so that the decay of the terminal signal of the data line is prevented. The two COFs connected to a same scan line 202 simultaneously output the scan signals having the same magnitude to the same scan line 202, so as to provide the switching control signals by the scan line 202 to the sub-pixels in the same column, so that a non-uniform display in brightness due to the scan line being undercharged is prevented.

In the above embodiments, the description of each embodiment has its emphasis, and for the parts that are not detailed in some embodiment, reference may be made to the relevant description of the other embodiments, and will not be described herein redundantly.

Those skilled in the art will realize that the word “preferable” means serving as an example, instance, or illustration. Any embodiment described herein as “preferable” is not necessarily to be construed as preferred or advantageous over other embodiments. Rather, use of the word “preferable” is intended to present concepts in a concrete manner. As used in this application, the term “or” is intended to mean an inclusive “or” rather than an exclusive “or”. That is, unless specified otherwise, or clear from context, “X employs 101 or 102” is intended to mean any of the natural inclusive permutations. That is, if X employs 101; X employs 102; or X employs both 101 and 102, then “X employs 101 or 102” is satisfied under any of the foregoing instances.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, with regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such a feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above descriptions are merely preferable embodiments of the present invention, but are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A curved display panel, comprising a pixel structure disposed on the curved display panel, a data line used to provide a data signal to the pixel structure, and a scan line used to provide a switching control signal to the pixel structure;
four rims of the curved display panel consisting of two first rims and two second rims, the first rim neighbored to the second rim, the first rim being a curved rim, a length of the first rim being greater than a length of the second rim, wherein the pixel structure comprises:
at least two pixel units, wherein each of the pixel units comprises at least three sub-pixels, each of the sub-pixels is configured as a rectangle, each of the sub-pixels comprises a long side and a short side;
two data driving circuits being respectively disposed on a corresponding outside of the first rims, wherein the data driving circuit disposed on the outside of one of the first rims and the data driving circuit disposed on the outside of the other first rim are connected to a same data line, the two data driving circuits simultaneously output the data signals to the same data line; and
two scan driving circuits being respectively disposed on a corresponding outside of the second rim, wherein the scan driving circuit disposed on the outside of one of the second rims and the scan driving circuit disposed on the outside of the other second rim are connected to a same scan line, the two scan driving circuits simultaneously output scan signals to the same scan line.

2. The curved display panel according to claim 1, characterized in that:
the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

3. The curved display panel according to claim 1, wherein the scan line is perpendicular to the first rim and parallel to the second rim.

4. The curved display panel according to claim 1, wherein the data line is perpendicular to the second rim and parallel to the first rim.

5. The curved display panel according to claim 1, wherein the data driving circuit and the scan driving circuit are packaged by using a chip-on-film (COF) packaging technology.

6. A curved display panel, comprising a pixel structure disposed on the curved display panel, a data line used to provide a data signal to the pixel structure, and a scan line used to provide a switching control signal to the pixel structure;
four rims of the curved display panel consisting of two first rims and two second rims, the first rim neighbored to the second rim, the first rim being a curved rim, a length of the first rim being greater than a length of the second rim, wherein the pixel structure comprises:
at least two pixel units, wherein each of the pixel units comprises at least three sub-pixels, each of the sub-pixels is configured as a rectangle, each of the sub-pixels comprises a long side and a short side;
two data driving circuits being respectively disposed on a corresponding outside of the first rims, wherein the two data driving circuits simultaneously output the data signals to a same data line; and
two scan driving circuits being respectively disposed on a corresponding outside of the second rim, wherein the two scan driving circuits simultaneously output scan signals to the same scan line.

7. The curved display panel according to claim 6, characterized in that:
the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

8. The curved display panel according to claim 6, characterized in that,
the data driving circuit disposed on an outside of one of the first rims and the other data driving circuit disposed on an outside of the other first rim are connected to the same data line.

9. The curved display panel according to claim 6, characterized in that,
the scan driving circuit disposed on an outside of one of the second rims and the other scan driving circuit disposed on an outside of the other second rim are connected to a same scan line.

10. The curved display panel according to claim 6, wherein the scan line is perpendicular to the first rim and parallel to the second rim.

11. The curved display panel according to claim 6, wherein the data line is perpendicular to the second rim and parallel to the first rim.

12. The curved display panel according to claim 6, wherein the data driving circuit and the scan driving circuit are packaged by using a chip-on-film (COF) packaging technology.

13. A curved display device, comprising a curved display panel, a pixel structure disposed on the curved display panel, a data line used to provide a data signal to the pixel structure, and a scan line used to provide a switching control signal to the pixel structure;
four rims of the curved display panel consisting of two first rims and two second rims, the first rim neighbored to the second rim, the first rim being a curved rim, a length of the first rim being greater than a length of the second rim, wherein the pixel structure comprises:
at least two pixel units, wherein each of the pixel units comprises at least three sub-pixels, each of the sub-pixels is configured as a rectangle, each of the sub-pixels comprises a long side and a short side;
two data driving circuits being respectively disposed on a corresponding outside of the first rims, wherein the two data driving circuits simultaneously output the data signals to a same data line; and
two scan driving circuits being respectively disposed on a corresponding outside of the second rim, wherein the two scan driving circuits simultaneously output scan signals to the same scan line.

14. The curved display device according to claim 13, wherein:
the long side of each of the sub-pixels is parallel with the first rim, the short side of each of the sub-pixels is parallel with the second rim, the long side of each of the sub-pixels is perpendicular to the second rim, and the short side of each of the sub-pixels is perpendicular to the first rim.

15. The curved display device according to claim 13, characterized in that:
the data driving circuit disposed on an outside of one of the first rims and the other data driving circuit disposed on an outside of the other first rim are connected to the same data line;
the scan driving circuit disposed on an outside of one of the second rims and the other scan driving circuit disposed on an outside of the other second rim are connected to a same scan line.
